(19) United States
(12) Patent Application Publication
(10) Pub. No.: US 2016/0065523 A1
(43) Pub. Date: Mar. 3, 2016

(54) METHOD FOR REAL-TIME LOCATION BASED CLOSE QUARTERS INTRODUCTIONS

(71) Applicant: BENJAMIN HINTZ, BRISTOL, CT (US)

(72) Inventor: BENJAMIN HINTZ, BRISTOL, CT (US)

(21) Appl. No.: 14/475,572

(22) Filed: Sep. 3, 2014

(51) Int. Cl. H04L 12/58; H04L 29/08

(52) U.S. Cl. CPC H04L 51/20; H04L 67/18

(57) ABSTRACT

A method for making introductions between consenting members of an online community based on the real time physical location of the consenting members. The method allows members to digitally communicate with strangers they meet whilst performing their daily activities and then the members can decide whether to follow up the digital communication with a face to face interaction. This method eliminates the awkwardness and the risks associated When an individual has an interest in introducing themselves to a stranger that they come across.

### TECHNICAL FIELD

The present invention is generally directed to the field of communications. More particularly the invention comprises a method for making location based contact between individuals who are in close quarters to one another such as being within observable distance from one another.

### BACKGROUND OF THE INVENTION

Often times people encounter strangers that they would like to initiate contact with such as while being at a gathering, or in a market, or at a party, or even on the street, however, due to shyness, or, for fear of more serious consequences, people do not initiate contact and are left to wonder what could have happened if they had initiated the contact.

It is desirable to have a method that would allow strangers who observe each other in close quarters to initiate contact with one another. This method would allow users to locate the electronic contact information of the stranger that they observe and then to electronically communicate with that stranger in order to build a comfort level and then to possibly initiate a face to face conversation. It is also desirable to have a method that would enable users to avoid rejection or to be stigmatized for talking to strangers.

From the above, it is therefore seen that there exists a need in the an to overcome the deficiencies and limitations described herein and above.

### SUMMARY OF THE INVENTION

The shortcomings of the prior art are overcome and additional advantages are provided through the use of a method for location based communication by consenting members of an online community comprising: a first consenting member and a second consenting member; the first consenting member within close physical proximity to the second consenting member; the first consenting member using an app which performs a real time location based search to locate the online profile of the second consenting member; the first consenting member sending digital communication to the second consenting member; the second consenting member having the option to accept or to reject the digital communication from the first consenting member; the first consenting member and the second consenting member having the option to follow up the digital communication between them with a face to face conversation; wherein, the app uses GPS technology to perform real-time searches of profiles of members in close physical proximity to the first consenting member.

Additional features and advantages are realized through the techniques of the present invention. Other embodiments and aspects of the invention are described in detail herein and are considered a part of the claimed invention.

The recitation herein of desirable embodiments is not meant to imply or suggest that any or all of these embodiments are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 illustrates an embodiment of a Global Positioning System (GPS) based communications system presenting the sequence of steps that occur during the communication process and the advantages of this method.

### DETAILED DESCRIPTION

The present invention pertains to a system for initiating contact with strangers that one observes whilst going about one's daily activities. For example, one can be in a market and observe a stranger that they have an interest in talking to. The method described herein allows access to the online profile of the stranger that one has observed by using a GPS based application (app). The GPS app returns results based on the real-time location of the user. The user can then match the app's returned profile picture with the stranger that they have observed and that they are interested in talking to and then they can proceed to initiate electronic communication with the stranger. The users can then assess their respective interest in one another and decide whether they are going to approach each other and carry on a face to face conversation.

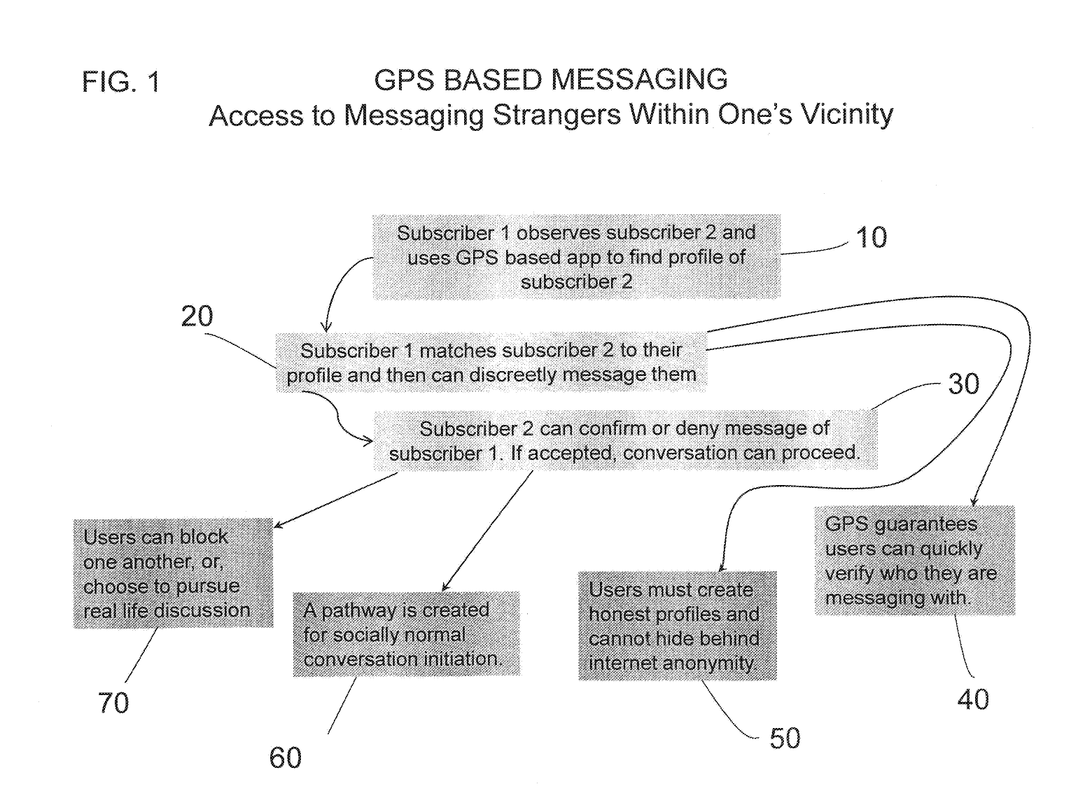

Referring to FIG. 1, in one embodiment the sequence of events that take place to gain access to communicating with strangers in close vicinity is described. The first step 10 begins when a first subscriber to the online community observes a second subscriber. The first subscriber then uses a GPS based app, which can be on his mobile device or other electronic device, to search for the online profile of the second user. The GPS based app uses the real time location of the first user to return results for other users that are in close proximity to the first user. In one embodiment the results can be ranked in order of proximity from the user. The first user can then view the profile of the second user 20 and match the profile picture or description of the second user to the real time image that the first user observes. If the profile image or description matches the real time image the first user can then discreetly message the second user. The second user receives the first user's message 30 and can then confirm or deny the first user's request for further communication.

This method of initiating contact with strangers has many advantages some of which are further outlined. By using GPS technology to locate people in close vicinity to the users, users are able to quickly verify who is messaging them 40. Also, fake profiles, which are abundant on other social networks, would be ineffective, because, this system would induce the user to create an honest profile, otherwise risk quickly being exposed 50. This system also creates a pathway and a progression towards a socially acceptable method of initiating conversations. Finally, it is easy and convenient to block the communication of another user or to choose to pursue the communication further 70.

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

What is claimed is:

1. A method for location based communication by consenting members of an online community comprising:
a first consenting member and a second consenting member;
the first consenting member within close physical proximity to the second consenting member;
the first consenting member using an app which performs a real time location based search to locate the online profile of the second consenting member;
the first consenting member sending digital communication to the second consenting member;
the second consenting member having the option to accept or to reject the digital communication from the first consenting member;
the first consenting member and the second consenting member having the option to follow up the digital communication between them with a face to face conversation;
wherein,
the app uses GPS technology to perform real-time searches of profiles of members in close physical proximity to the first consenting member.

2. The location based communication system of claim 1 wherein the app ranks search results based on the physical proximity of the members.

3. The location based communication system of claim 1 wherein the consenting members are within 300 feet of each other.

4. The location based communication system of claim 1 wherein the digital communication used to communicate between the consenting members is comprised of text messaging or email.

5. The location based communication system of claim 1 wherein the consenting members can select the personal information entries that will be made public in the online profile.
